(19) United States
(12) Patent Application Publication
(10) Pub. No.: US 2024/0412655 A1
(43) Pub. Date: Dec. 12, 2024

(54) METHOD, SYSTEM AND NON-TRANSITORY COMPUTER-READABLE RECODING MEDIUM FOR CREATING LEARNING PROBLEMS

(71) Applicant: VITRUV INC., Seoul (KR)

(72) Inventors: Tae Hyoung OH, Seoul (KR); Du Seop JUNG, Seongnam-si Gyeonggi-do (KR); Myunghoon AHN, Seoul (KR); Sang Hoon LEE, Seoul (KR)

(73) Assignee: VITRUV INC., Seoul (KR)

(21) Appl. No.: 18/702,890

(22) PCT Filed: Oct. 20, 2022
(86) PCT No.: PCT/KR2022/016063

§ 371 Date: Apr. 19, 2024

(30) Foreign Application Priority Data
Oct. 20, 2021 (KR) 10-2021-0140178

(51) Int. Cl. G09B 7/02; G06F 40/166

(52) U.S. Cl. CPC G09B 7/02; G06F 40/166

(57) ABSTRACT

A method for creating learning problems is provided. The method includes the steps of: with reference to setting information on a reference learning problem, determining changeable areas in the reference learning problem, and determining ranges of data change in the changeable areas; changing data included in at least one of the determined changeable areas, within the range of data change in the at least one changeable area; and creating a new learning problem from the reference learning problem on the basis of the changed data.

### FIELD OF THE INVENTION

The present invention relates to a method, system, and non-transitory medium for computer-readable recording creating learning problems.

### BACKGROUND

The market for learning contents is growing due to the demand for education and fierce entrance examination competition. In addition, various studies are being conducted to develop learning contents capable of effectively supporting learning.

In particular, there is a need for a technique for automatically creating a large number of learning problems for repetitive learning, therapeutic learning, or testing.

As an example of conventional techniques, Korean Registered Patent Publication No. 10-1621828 discloses a system for automatically creating random algebraic equations. However, according to the conventional techniques for creating learning problems by randomly determining numbers or characters, it is difficult to reflect the context of a learning situation or a learner when creating learning problems, which makes it difficult to create learning problems suitable for a specific situation or a specific learner (e.g., a number of learning problems with difficulty adjusted to a certain level).

Further, according to the conventional techniques, new learning problems are created by making limited changes only to the formulas or texts included in existing learning problems, which makes it difficult to create a variety of learning problems.

### SUMMARY OF THE INVENTION

One object of the present invention is to solve all the above-described problems in the prior art.

Another object of the invention is to provide a method comprising the steps of: with reference to setting information on a reference learning problem, determining changeable areas in the reference learning problem, and determining ranges of data change in the changeable areas; changing data included in at least one of the determined changeable areas, within the range of data change in the at least one changeable area; and creating a new learning problem from the reference learning problem on the basis of the changed data.

The representative configurations of the invention to achieve the above objects are described below.

According to one aspect of the invention, there is provided a method comprising the steps of: with reference to setting information on a reference learning problem, determining changeable areas in the reference learning problem, and determining g ranges of data change in the changeable areas; changing data included in at least one of the determined changeable areas, within the range of data change in the at least one changeable area; and creating a new learning problem from the reference learning problem on the basis of the changed data.

According to another aspect of the invention, there is provided a system comprising: a range-of-change determination unit configured to, with reference to setting information on a reference learning problem, determine changeable areas in the reference learning problem, and determine ranges of data change in the changeable areas; a data change unit configured to change data included in at least one of the determined changeable areas, within the range of data change in the at least one changeable area; and a new learning problem creation unit configured to create a new learning problem from the reference learning problem on the basis of the changed data.

In addition, there are further provided other methods and systems to implement the invention, as well as non-transitory computer-readable recording media having stored thereon computer programs for executing the methods.

According to the invention, it is possible to create a learning problem by changing data included in a changeable area set for a reference learning problem within a range of change, so that a large number of learning problems suitable for a specific situation or a specific learner may be efficiently created.

According to the invention, it is possible to create more diverse learning problems by adaptively changing visual elements such as figures as well as formulas or texts included in existing learning problems.

### BRIEF DESCRIPTION OF THE DRAWINGS

FIG. 1 schematically shows the configuration of an entire system for creating learning problems according to one embodiment of the invention

FIG. 2 specifically shows the internal configuration of a learning problem creation system according to one embodiment of the invention.

FIG. 3 illustratively shows creating learning problems according to one embodiment of the invention.

FIG. 4 illustratively shows creating learning problems according to one embodiment of the invention.

### DETAILED DESCRIPTION OF THE INVENTION

In the following detailed description of the present invention, references are made to the accompanying drawings that show, by way of illustration, specific embodiments in which the invention may be practiced. These embodiments are described in sufficient detail to enable those skilled in the art to practice the invention. It is to be understood that the various embodiments of the invention, although different from each other, are not necessarily mutually exclusive. For example, specific shapes, structures and characteristics described herein may be implemented as modified from one embodiment to another without departing from the spirit and scope of the invention. Furthermore, it shall be understood that the positions or arrangements of individual elements within each embodiment may also be modified without departing from the spirit and scope of the invention. Therefore, the following detailed description is not to be taken in a limiting sense, and the scope of the invention is to be taken as encompassing the scope of the appended claims and all equivalents thereof. In the drawings, like reference numerals refer to the same or similar elements throughout the several views.

Hereinafter, various preferred embodiments of the invention will be described in detail with reference to the accompanying drawings to enable those skilled in the art to easily implement the invention.

### Configuration of the Entire System

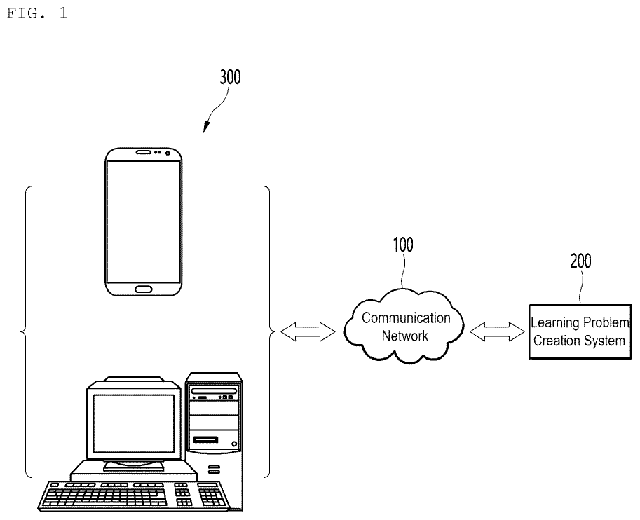

FIG. 1 schematically shows the configuration of the entire system for creating learning problems according to one embodiment of the invention

As shown in FIG. 1, the entire system according to one embodiment of the invention may comprise a communication network 100, a learning problem creation system 200, and a device 300.

First, the communication network 100 according to one embodiment of the invention may be implemented regardless of communication modality such as wired and wireless communications, and may be constructed from a variety of communication networks such as local area networks (LANs), metropolitan area networks (MANs), and wide area networks (WANs). Preferably, the communication network 100 described herein may be the Internet or the World Wide Web (WWW). However, the communication network 100 is not necessarily limited thereto, and may at least partially include known wired/wireless data communication networks, known telephone networks, or known wired/wireless television communication networks.

For example, the communication network 100 may be a wireless data communication network, at least a part of which may be implemented with a conventional communication scheme such as radio frequency (RF) communication, WiFi communication, cellular communication (e.g., Long Term Evolution (LTE) communication), Bluetooth communication (more specifically, Bluetooth Low Energy (BLE) communication), infrared communication, and ultrasonic communication.

Next, the learning problem creation system 200 according to one embodiment of the invention may function to: with reference to setting information on a reference learning problem, determine changeable areas in the reference learning problem, and determine ranges of data change in the changeable areas; change data included in at least one of the determined changeable areas, within the range of data change in the at least one changeable area; and create a new learning problem from the reference learning problem on the basis of the changed data, and may automatically create a large number of new learning problems for repetitive learning, therapeutic learning, or testing.

The configuration and functions of the learning problem creation system 200 according to one embodiment of the invention will be discussed in detail below.

Next, the device 300 according to one embodiment of the invention is digital equipment capable of connecting to and then communicating with the learning problem creation system 200, and any type of digital equipment having a memory means and a microprocessor for computing capabilities, such as a smart phone, a tablet, a smart watch, a smart band, smart glasses, a desktop computer, a notebook computer, a workstation, a personal digital assistant (PDAs), a web pad, and a mobile phone, may be adopted as the device 300 according to the invention.

Meanwhile, the device 300 may include an application (not shown) for assisting a user to receive services according to the invention from the learning problem creation system The application may be downloaded from the learning 200. problem creation system 200 or an external application distribution server (not shown). Meanwhile, the characteristics of the application may be generally similar to those of a range-of-change determination unit 210, a data change unit 220, a new learning problem creation unit 230, a communication unit 240, and a control unit 250 of the learning problem creation system 200 to be described below. Here, at least a part of the application may be replaced with a hardware device or a firmware device that may perform a substantially equal or equivalent function, as necessary.

Next, according to one embodiment of the invention, the device 300 is digital equipment capable of connecting to and then communicating with the learning problem creation system 200 via the communication network 100, and any type of digital equipment having a memory means and a microprocessor for computing capabilities, such as a smart phone and a tablet PC, may be adopted as the device 300 according to the invention.

### Configuration of the Learning Problem Creation System

Hereinafter, the internal configuration of the learning problem creation system 200 crucial for implementing the invention and the functions of the respective components thereof will be discussed.

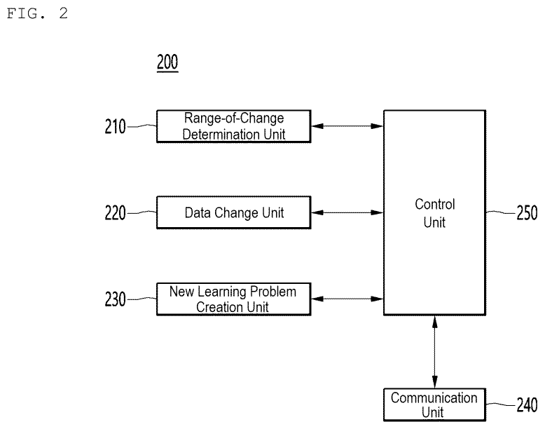

FIG. 2 specifically shows the internal configuration of the learning problem creation system 200 according to one embodiment of the invention.

As shown in FIG. 2, the learning problem creation system 200 according to one embodiment of the invention may comprise a range-of-change determination unit 210, a data change unit 220, a new learning problem creation unit 230, a communication unit 240, and a control unit 250. According to one embodiment of the invention, at least some of the range-of-change determination unit 210, the data change unit 220, the new learning problem creation unit 230, the communication unit 240, and the control unit 250 of the learning problem creation system 200 may be program modules to communicate with an external system (not shown). The program modules may be included in the learning problem creation system 200 in the form of operating systems, application program modules, or other program modules, while they may be physically stored in a variety of commonly known storage devices. Further, the program modules may also be stored in a remote storage device that may communicate with the learning problem creation system 200. Meanwhile, such program modules may include, but are not limited to, routines, subroutines, programs, objects, components, data structures, and the like for performing specific tasks or executing specific abstract data types as will be described below in accordance with the invention.

Meanwhile, the above description is illustrative although the learning problem creation system 200 has been described as above, and it will be apparent to those skilled in the art that at least a part of the components or functions of the learning problem creation system 200 may be implemented in the device 300 or a server (not shown) or included in an external system (not shown), as necessary.

First, the range-of-change determination unit 210 according to one embodiment of the invention may function to, with reference to setting information on a reference learning problem, determine changeable areas in the reference learning problem, and determine ranges of data change in the changeable areas, thereby determining a range of change of data for creating a new learning problem.

For example, the setting information on the reference learning problem may be preset by an administrator or extracted from the reference learning problem. The range-of-change determination unit 210 may determine ranges of data change with reference to the setting information extracted from an exemplary reference learning problem.

Specifically, the changeable area determined by the range-of-change determination unit 210 according to one embodiment of the invention may include at least one of a text area, a formula area, a figure area, a graph area, and an image area. Likewise, various types of areas may be determined as changeable areas in a learning problem. However, the various types of areas determined as the changeable areas are not necessarily limited to the examples listed above, and may include various types of areas as long as the objects of the invention may be achieved.

Further, according to one embodiment of the invention, the ranges of data change in the changeable areas of the reference learning problem may be determined on the basis of context information on the reference learning problem or the new learning problem. For example, the context information on the new learning problem may include at least one of a condition of the reference learning problem, a concept associated with the reference learning problem, a difficulty level of the reference learning problem, a difficulty level of the new learning problem, an academic achievement level of a learner or user to be provided with the new learning problem, and a concept understanding level of the learner or user to be provided with the new learning problem.

Specifically, the ranges of data change may be determined on the basis of context information of a learning problem (e.g., a difficulty level of the reference learning problem and a difficulty level of the new learning problem) to adjust a difficulty level of learning of the user or learner. The ranges of data change may be determined on the basis of context information of a learning problem such as a difficulty level of the new learning problem. Further, a difficulty level of a learning problem may be determined on the basis of a learning concept, formula, image, and the like included in the problem.

For example, in order to prevent the difficulty level of the new learning problem from being significantly different from the difficulty level of the reference learning problem as numbers in the learning problem are changed significantly, the range of change in data included in a text area or formula area of the reference learning problem may be limited to a predetermined numerical range. As another example, in order to prevent the difficulty level of the new learning problem from being significantly different from the difficulty level of the reference learning problem as an image required to solve the learning problem is changed significantly, the range of change in data included in an image area of the reference learning problem may be limited to a predetermined range. As another example, in order to prevent the difficulty level of the new learning problem from being significantly increased relative to the difficulty level of the reference learning problem as the problem length of the learning problem is increased significantly, the range of change in data included in a problem length text area of the reference learning problem may be limited to a predetermined numerical range.

Further, the ranges of data change may be determined on the basis of context information of a learning problem, such as repetitive learning, therapeutic learning, or testing. For example, specific numbers or images included in a learning problem may be changed for repetitive learning of the user or learner. By changing the numbers or images included in the learning problem, learning problems may be created repeatedly. As another example, the data may be changed for therapeutic learning of the user or learner, such that the data is changed to treat a learning disability of the user or learner, wherein the learning disability may include dyslexia, learning deficits, and the like. Finally, it may be necessary to conduct an academic test for evaluating an academic achievement level of the user or learner, and data in learning problems may be changed within a predetermined range of change in order to conduct the test for evaluating the academic achievement level of the user or learner.

Meanwhile, it is noted that the method of determining changeable areas in the reference learning problem whose ranges of change are to be determined by the range-of-change determination unit 210, and the method of determining ranges of data change in the changeable areas are not necessarily limited to the examples listed above, and may be diversely changed as long as the objects of the invention may be achieved.

Next, the data change unit 220 according to one embodiment of the invention may change data included in at least one of the changeable areas, within the range of data change in the at least one changeable area.

More specifically, in the data change unit 220 according to one embodiment of the invention, the range of data change in a first changeable area and the range of data change in a second changeable area may be interlinked with each other. The first changeable area may include various types of areas such as a text area, a formula area, a figure area, a graph area, and an image area. Further, the second changeable area may include various types of areas such as a text area, a formula area, a figure area, a graph area, and an image area, and the ranges of data change in the first changeable area and the second changeable area may be interlinked with each other. Meanwhile, the various types of areas in the first changeable area and the second changeable area whose data are to be changed by the data change unit 220 are not necessarily limited to the examples listed above, and may include various areas as long as the objects of the invention may be achieved.

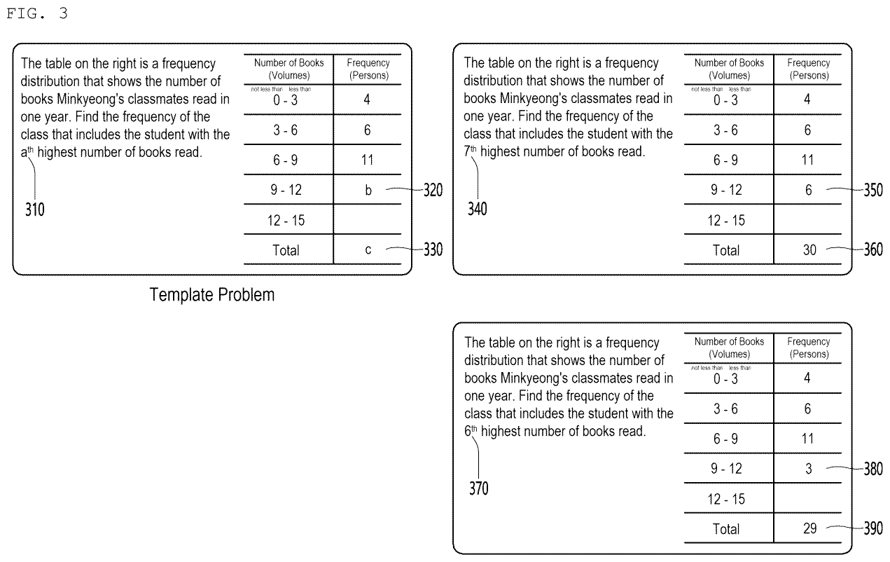

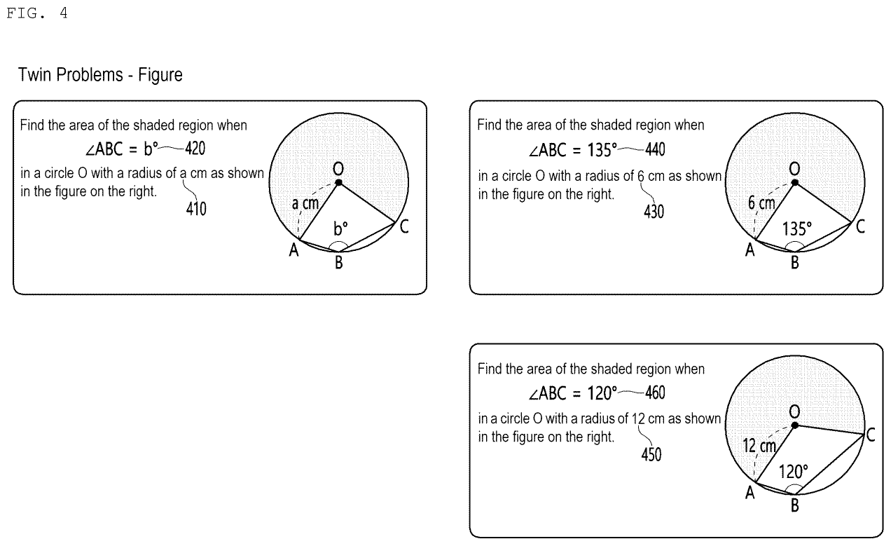

Next, FIGS. 3 and 4 illustratively show creating learning problems according to one embodiment of the invention.

First, FIG. 3 illustratively shows creating new learning problems according to one embodiment of the invention, wherein it can be seen that data 310, 320, 330 in text areas of a reference learning problem may be changed to create new learning problems. Specifically, changeable areas of the reference learning problem may include a text area, a formula area, a figure area, a graph area, an image area, and the like, and FIG. 3 illustratively shows that the data 310, 320, 330 in the text areas of the reference learning problem are changed to create new learning problems. More specifically, in order to maintain difficulty levels of the newly created learning problems, ranges of data change may be set to a range that does not affect the manner of solving the reference learning problem. Further, data 340, 350, 360, 370, 380, 390 in the text areas may be changed within a range that does not introduce errors in the new learning problems and their answers.

Next, FIG. 4 illustratively shows creating new learning problems according to one embodiment of the invention, wherein it can be seen that data 410, 420 in text areas and an image area of a reference learning problem may be adaptively changed to create new learning problems. Specifically, changeable areas of the reference learning problem may include a text area, a formula area, a figure area, a graph area, an image area, and the like, and FIG. 4 illustratively shows that the data 410, 420 in the text areas of the reference learning problem are changed, and the image area is adaptively changed in response to the changes to create new learning problems. Further, in order to maintain difficulty levels of the newly created learning problems, ranges of data change may be set to a range that does not affect the manner of solving the reference learning problem. Furthermore, data 430, 440, 450, 460 in the text areas may be changed within a range that does not introduce errors in the new learning problems and their answers.

More specifically, FIG. 4 illustratively shows that as the data 410, 420 in the text areas included in the reference learning problem are changed, the visually displayed image area may be adaptively changed. The adaptively changed image area may include a circular figure, a fan-shaped figure, a triangular figure, a cube, a three-dimensional view of a figure, and the like in the learning problem. However, the image area adaptively changed in response to the changes in the data 430, 440, 450, 460 in the text areas is not necessarily limited to the examples listed above, and may include various types of areas as long as the objects of the invention may be achieved.

Next, the new learning problem creation unit 230 according to one embodiment of the invention may create a new learning problem from the reference learning problem on the basis of the changed data.

Specifically, according to one embodiment of the invention, in the step of creating a new learning problem from the reference learning problem on the basis of the changed data, the new learning problem may be created by adaptively changing visual elements included in the reference learning problem. In this way, the user or learner may be continuously provided with learning problems with types that are not different, and may be provided with learning problems with difficulty levels that are not different, as the ranges of data change in the first changeable area and the second changeable area are interlinked with each other. Further, according to one embodiment of the invention, a large number of learning problems may be automatically created for repetitive learning, therapeutic learning, or testing, and these learning problems may be provided to the user or learner.

Next, the communication unit 240 according to one embodiment of the invention may function to enable data transmission/reception from/to the range-of-change determination unit 210, the data change unit 220, and the new learning problem creation unit 230.

Lastly, the control unit 250 according to one embodiment of the invention may function to control data flow among the range-of-change determination unit 210, the data change unit 220, the new learning problem creation unit 230, and the communication unit 240. That is, the control unit 250 according to the invention may control data flow into/out of the learning problem creation system 200 or data flow among the respective components of the learning problem creation system 200, such that the range-of-change determination unit 210, the data change unit 220, the new learning problem creation unit 230, and the communication unit 240 may carry out their particular functions, respectively.

The embodiments according to the invention as described above may be implemented in the form of program instructions that can be executed by various computer components, and may be stored on a computer-readable recording medium. The computer-readable recording medium may include program instructions, data files, and data structures, separately or in combination. The program instructions stored on the computer-readable recording medium may be specially designed and configured for the present invention, or may also be known and available to those skilled in the computer software field. Examples of the computer-readable recording medium include the following: magnetic media such as hard disks, floppy disks and magnetic tapes; optical media such as compact disk-read only memory (CD-ROM) and digital versatile disks (DVDs); magneto-optical media such as floptical disks; and hardware devices such as read-only memory (ROM), random access memory (RAM) and flash memory, which are specially configured to store and execute program instructions. Examples of the program instructions include not only machine language codes created by a compiler, but also high-level language codes that can be executed by a computer using an interpreter. The above hardware devices may be changed to one or more software modules to perform the processes of the present invention, and vice versa.

Although the present invention has been described above in terms of specific items such as detailed elements as well as the limited embodiments and the drawings, they are only provided to help more general understanding of the invention, and the present invention is not limited to the above embodiments. It will be appreciated by those skilled in the art to which the present invention pertains that various modifications and changes may be made from the above description.

Therefore, the spirit of the present invention shall not be limited to the above-described embodiments, and the entire scope of the appended claims and their equivalents will fall within the scope and spirit of the invention.

1. A method for creating learning problems, the method comprising the steps of:
with reference to setting information on a reference learning problem, determining changeable areas in the reference learning problem, and determining ranges of data change in the changeable areas;
changing data included in at least one of the determined changeable areas, within the range of data change in the at least one changeable area; and
creating a new learning problem from the reference learning problem on the basis of the changed data.

2. The method of claim 1, wherein the setting information is preset by an administrator or extracted from the reference learning problem.

3. The method of claim 1, wherein the changeable area includes at least one of a text area, a formula area, a figure area, a graph area, and an image area.

4. The method of claim 1, wherein the range of data change in the at least one changeable area is determined on the basis of context information on the reference learning problem or the new learning problem.

5. The method of claim 4, wherein the context information includes at least one of a condition of the reference learning problem, a concept associated with the reference learning problem, a difficulty level of the reference learning problem, a difficulty level of the new learning problem, an academic achievement level of a learner to be provided with the new learning problem, and a concept understanding level of the learner to be provided with the new learning problem.

6. The method of claim 1, wherein the range of data change in a first changeable area and the range of data change in a second changeable area are interlinked with each other.

7. The method of claim 1, wherein in the creating step, the new learning problem is created by adaptively changing visual elements included in the reference learning problem on the basis of the changed data.

8. A non-transitory computer-readable recording medium having stored thereon a computer program for executing the method of claim 1.

9. A system for creating learning problems, the system comprising:
a range-of-change determination unit configured to, with reference to setting information on a reference learning problem, determine changeable areas in the reference learning problem, and determine ranges of data change in the changeable areas;
a data change unit configured to change data included in at least one of the determined changeable areas, within the range of data change in the at least one changeable area; and
a new learning problem creation unit configured to create a new learning problem from the reference learning problem on the basis of the changed data.

10. The system of claim 9, wherein the setting information is preset by an administrator or extracted from the reference learning problem.

11. The system of claim 9, wherein the changeable area includes at least one of a text area, a formula area, a figure area, a graph area, and an image area.

12. The system of claim 9, wherein the range of data change in the at least one changeable area is determined on the basis of context information on the reference learning problem or the new learning problem.

13. The system of claim 12, wherein the context information includes at least one of a condition of the reference learning problem, a concept associated with the reference learning problem, a difficulty level of the reference learning problem, a difficulty level of the new learning problem, an academic achievement level of a learner to be provided with the new learning problem, and a concept understanding level of the learner to be provided with the new learning problem.

14. The system of claim 9, wherein the range of data change in a first changeable area and the range of data change in a second changeable area are interlinked with each other.

15. The system of claim 9, wherein the new learning problem creation unit is configured to create the new learning problem by adaptively changing visual elements included in the reference learning problem on the basis of the changed data.
